(19) United States
(12) Patent Application Publication
(10) Pub. No.: US 2003/0062764 A1
(43) Pub. Date: Apr. 3, 2003

(54) Hub assembly for a vehicle wheel and a method for manufacturing it

(75) Inventors: Angelo Vignotto, Torino (IT); Daniele Forestiero, Torino (IT)

Correspondence Address: MERCHANT & GOULD PC, P.O. BOX 2903, MINNEAPOLIS, MN, 55402-0903, US

(73) Assignee: SFK INDUSTRIE S.p.A., Torino (IT)

(21) Appl. No.: 10/263,883

(22) Filed: Oct. 2, 2002

(30) Foreign Application Priority Data
Oct. 2, 2001 (IT) TO2001A000933

(51) Int. Cl. B60B 27/00

(52) U.S. Cl. 301/105.1

(57) ABSTRACT

A hub for a motor vehicle wheel forms a central axial tubular projection with an outer cylindrical surface for inserting into a central hole through a wheel. An insert of non-oxidisable metal with a cylindrical portion is fixed to the cylindrical surface of the hub to cover this surface.

### DESCRIPTION

The present invention relates to a hub assembly for a wheel of a motor vehicle, of a type including a hub which forms a central axial tubular projection with an outer cylindrical surface for inserting into a central hole through a wheel. The invention also refers to a method for manufacturing a hub assembly of the type described above.

Hubs for motor vehicles are known which have a central tubular projection with a cylindrical surface on which the wheel is fitted in order to centre it, as a preliminary step in mounting it on the hub. The hub usually also has a radial flange bearing the bolts for fixing the wheel.

The wheel is mounted on the hub by fitting a central hole in the wheel over the tubular projection of the hub and inserting the bolts projecting from the flange of the hub into corresponding axial holes in the wheel. Locking nuts are then tightened onto the bolts. This tightening operation determines the final centring of the wheel relative to the hub, and leaves a narrow circumferential gap between the cylindrical surface of the hub projection and the central hole in the wheel.

Automobile manufacturers require the smallest possible radial clearance between the wheel's central hole and the hub projection in order that the centring provided by this projection ensures that the bolts are sufficiently accurately centred on the respective holes in the wheel for the nuts to be tightened without it being necessary for the person fitting the wheel to lift it in order to align it with the bolts.

It is inevitable that external contaminants (water, mud) which penetrate the aforesaid gap cause corrosion to form at the interface of the wheel and the tubular projection of the hub, thus making it difficult to remove the wheel from the hub. Automobile manufacturers are now requesting that this corrosion should be prevented, making it easier to change a wheel, when a tyre needs replacing for example.

Attempts have been made to prevent corrosion by coating the tubular projection of the hub with a layer of anti-corrosion material (applied as a varnish or by galvanisation). This has proved expensive since very costly machinery, which takes up a lot of space, has had to be installed in hub production lines. In particular, a first machine must be installed for washing and degreasing the hubs, a second for drying them, a third for applying the anti-corrosion coating and a fourth for drying the coating quickly.

In addition to incurring high costs owing to the installation of this extra machinery, this arrangement has practical disadvantages involving the layout of production lines, where there is usually little available space for additional equipment.

In order to prevent corrosion at the interface of the wheel and the hub, U.S. Pat. No. 5,975,647 in the name of the present Applicant, proposes extending a cover which usually closes the central opening of the hub, so that a cylindrical portion of the cover is interposed between the central hole in the wheel and the outer cylindrical surface of the tubular projection of the hub. A layer of anti-corrosion material is applied to this cover before it is fitted.

Both the known arrangements described above have proved unsatisfactory because they do not exclude the risk that the coating may become scratched in various places, either during production of the hub, while the wheel is being fitted onto the hub or, above all, while the wheel is being removed and refitted during the life of the vehicle. The scratches expose the non-treated surface of the hub and therefore create points where the formation of rust is triggered.

Another still different arrangement provides for an annular recess area to be formed on the tubular centring projection of the hub, thereby reducing the contact surface between the central hole through the wheel and the hub. Any corrosion that forms in the recess area provides little resistance when the wheel is being removed and can be tolerated. It has been found, however, that over time corrosion extends beyond the recess area, leading to the usual problem.

A general object of the present invention is thus to provide a simple and economical method of manufacturing a hub assembly able to overcome the aforesaid problems of the prior art and which, in particular, is able to prevent the formation of corrosion, without the need for expensive coating treatments or the associated machinery.

One particular object of the invention is to provide a hub assembly which provides lasting protection against the formation of corrosion at the interface with the wheel, even after the wheel has been repeatedly removed and replaced and even in the event of these operations being carried out by unskilled people.

A further object of the invention is to provide a hub assembly having a cylindrical centring surface of a precise diameter, in order to maintain the radial clearance between this surface and the central hole through the wheel to be mounted on the hub at a minimum.

According to a first aspect of the present invention, these objects are achieved by a hub assembly having the characteristics defined in claim 1.

According to another aspect of the invention, these objects are achieved by a method as claimed in claim 11.

Preferred embodiments of the invention are defined in the appended claims.

A few preferred embodiments of the invention will now be described purely by way of non-limitative example, with reference to the appended drawings, in which:

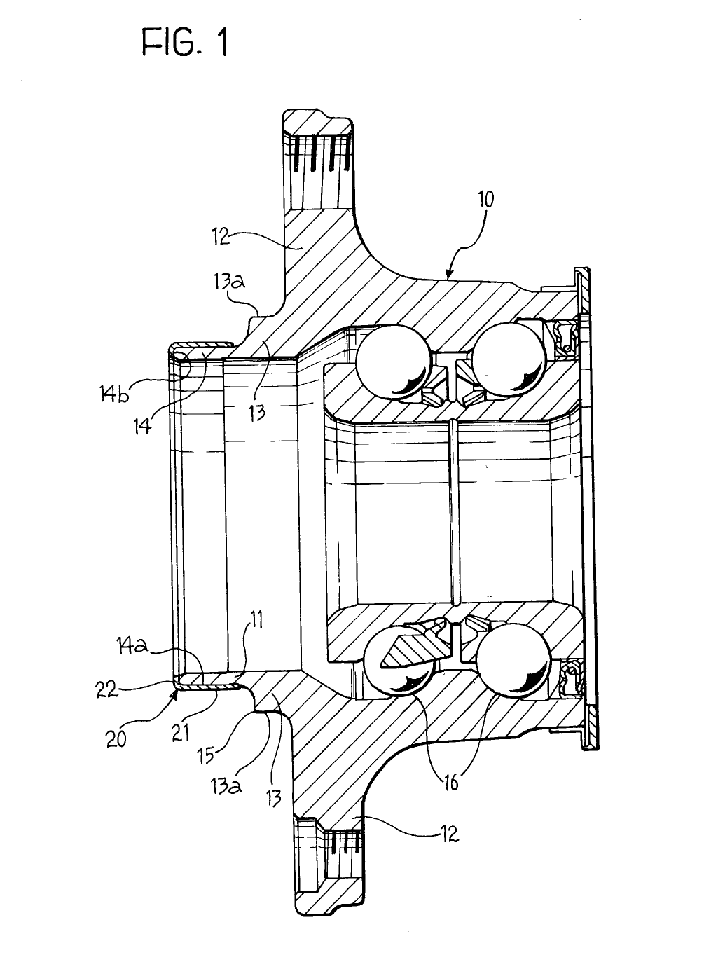

FIG. 1 is an axially sectioned view of a hub bearing unit including a hub assembly according to a first embodiment of the present invention;

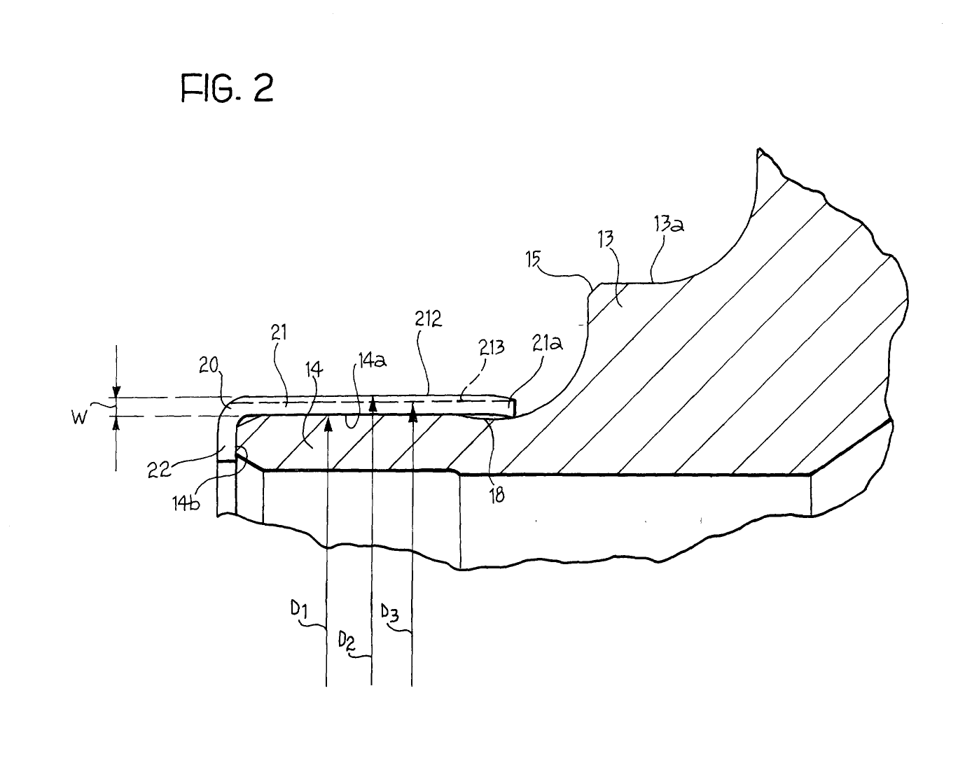

FIG. 2 is an enlarged view of a detail of FIG. 1;

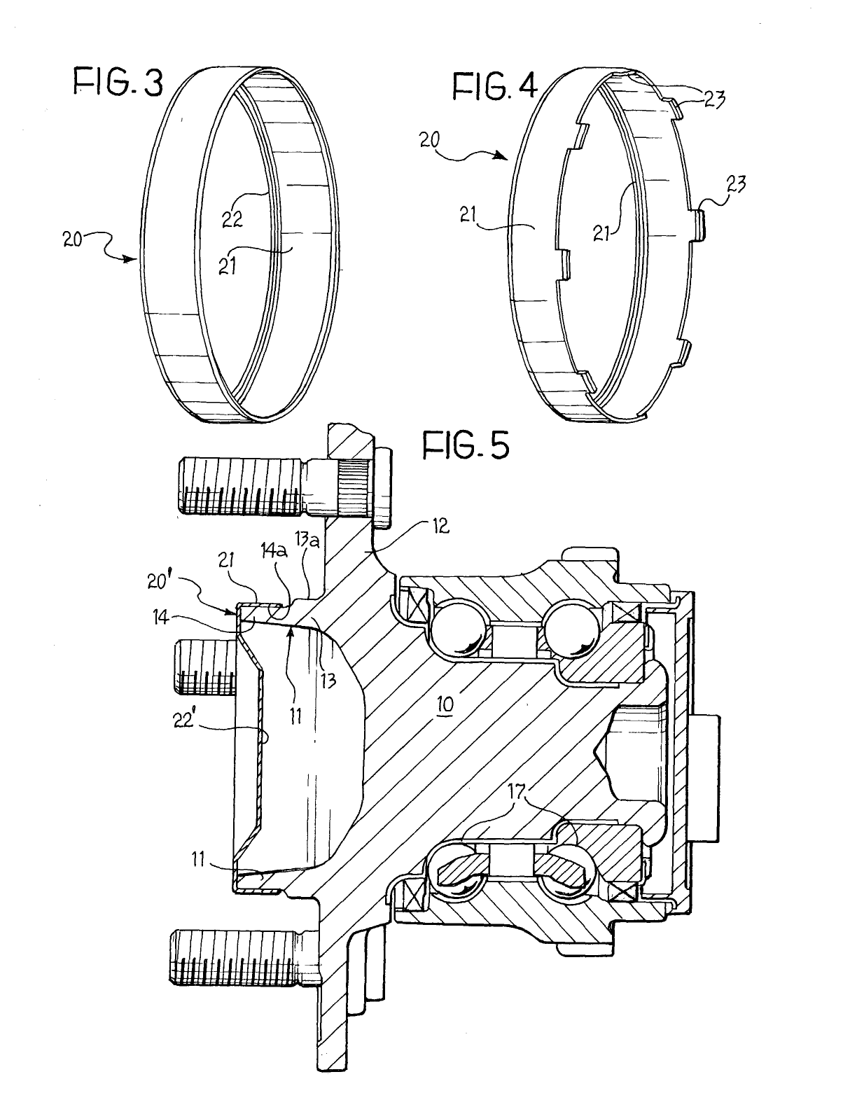

FIGS. 3 and 4 are perspective views of two respective variants of an insert to be incorporated into the hub assembly of the invention;

FIG. 5 is an axially sectioned view of a hub bearing unit which includes a hub assembly according to a second embodiment of the invention; and

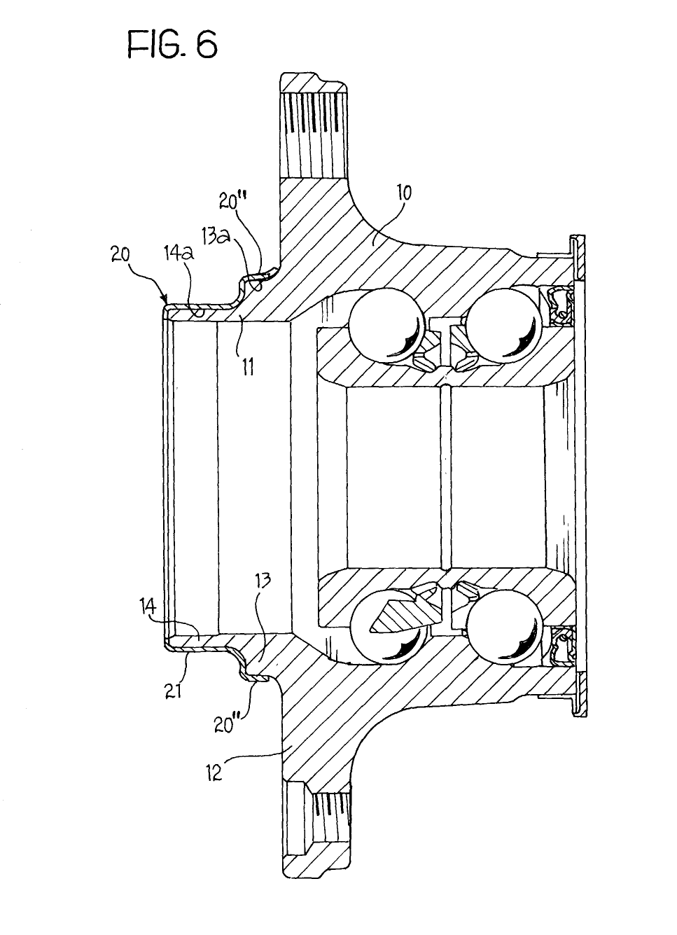

FIG. 6 is an axially sectioned view of a hub bearing unit which includes a hub assembly according to a third embodiment of the invention.

With reference first to FIG. 1, a hub for a motor vehicle wheel, of a generally conventional structure, is indicated 10. Consequently, only elements of specific importance and interest with regard to the embodiment of the invention will be described in the following description. For the manufacture of parts or elements not illustrated in detail, reference may be made to any hub bearing unit known in the art.

The hub 10, made of stainless steel, has a central tubular centring formation 11 which projects axially outwardly of the vehicle, and a radially projecting flange 12. Throughout this description and in the claims, terms and phrases indicating positions and orientations (such as “radial”, “axial”, “inner”, “outer”) refer to the axis of rotation x of the hub, unless it is indicated otherwise.

The tubular projection 11 includes a proximal portion 13 and a distal portion 14. Both portions 13 and 14 are of a cylindrical tubular shape but have different diameters; in particular, in accordance with a known structural arrangement, the diameter of the outer cylindrical surface 13a of the proximal portion 13, on which the flange of the brake rotor (not shown) is centred, is larger than that of the outer cylindrical surface 14a of the distal or terminal portion 14, on which the wheel (not shown) is centred. An annular step 15 is thus formed at the junction of the surfaces 13a and 14a. It should be noted that, although FIG. 1 shows a hub bearing unit of the type in which the hub 10 is fixed for rotation with or formed in one piece with the radially outer races 16 of the bearing, the reference to this possible field of application should not be seen in any way as limiting the scope of the invention. As shown, for example, in FIG. 5, the invention is equally applicable to hub bearing units in which the hub is fixed for rotation or formed in one piece with the radially inner races 17 of the bearing.

According to the invention, a cylindrical, annular insert of an non-oxidisable metal material, generally indicated 20 and shown separately in FIG. 3, is fixed onto the cylindrical surface 14a so as completely to cover this area of the hub which faces the central hole in the wheel (not shown) when this is mounted. The insert 20 is preferably force fitted onto the cylindrical surface 14a with radial interference.

The non-oxidisable insert 20 is advantageously manufactured by pressing it from stainless steel sheet, or from a sheet of another rust-proof metal or metal alloy with corrosion-resistant properties, such as brass, for example. Radially, the insert 20 can be very thin, for example in the region of 0.6 mm.

In the embodiment illustrated in FIGS. 1 to 4, the non-oxidisable insert 20 is annular, with an L-shape section, and has a cylindrical portion 21 which is long enough axially to cover the cylindrical surface 14a or, in any event, the area which is to be inserted into the central hole in the wheel, and a portion or radial edge 22 which, once installed, bears against the outer surface 14b of the tubular projection 11.

Tests carried out by the Applicant revealed that, given appropriate radial interference between the inner diameter of the cylindrical portion 21 of the insert 20 and the cylindrical surface 14a of the tubular projection 11 of the hub, it is practically impossible to remove the insert 20 from the hub once it has been force fitted. However, this coupling can be made even more secure by plastically deforming part of the cylindrical portion 21 of the insert 20 into a radial recess in the hub. In the embodiment of FIG. 2, the axially inner edge 21a is swaged into a groove or radial recess 18 formed near the step 15. This deformation can be carried out either by rolling or by swaging or by another method of fixing by cold plastic deformation. In the variant of FIG. 4, the axially inner edge area of the insert 20 has a series of axially projecting tabs 23 which are easy to bend over.

A preferred embodiment of the method of the invention will now be described with reference to FIG. 2. In order to obtain a centring surface which is both non-oxidisable and very accurate, and maintains at a minimum the radial clearance between the central hole in the wheel and the hub during fitting or removal of the wheel, it is convenient for the cylindrical surface 14a of the tubular projection 11 to have a diameter D1 which is significantly smaller than the desired final centring diameter D₃ which determines the minimum clearance demanded by the car industry.

This can be achieved by carrying out a preliminary rough turning operation on the surface 14a, whereby the diameter D₂ of the outer cylindrical surface 212 of the portion 21 fitted onto the hub, shown in an unbroken line in FIG. 2, is slightly greater than the desired final diameter D₃. This value of the final diameter is achieved by means of a simple turning operation which removes a thin layer from the outermost surface of the cylindrical portion 21, thereby obtaining a non-oxidisable cylindrical surface 213 with the desired final diameter D₃, as shown by the broken line in FIG. 2.

For example, if a final diameter D₃=57^{±0.3} mm is required, a first rough turning operation takes the diameter D₁ of the surface 14a to the value D₁=56^{±0.1} mm. Force fitting an insert with a radial thickness w=0.6 mm gives D₂=around 57.2 mm. A second, accurate turning operation gives a finished surface 213 with a diameter D₃=57^{±0.03} mm which accurately provides the desired radial clearance. In other words, the preferred embodiment of the method of the invention is represented by the following formula:

D₁+2w=D₂<D₃.

FIG. 5 shows an alternative embodiment of the invention, in which the insert indicated 20′ differs from the annular insert 20 of the previous figures in that it is in the form of a cap including a full radial wall 22′ closing the central cavity 19 of the hub of a non-driven wheel.

In a further embodiment of the invention, shown in FIG. 6 and also applicable equally to either driven or non-driven wheels, a portion 20″ of the non-oxidisable insert 20 extends to cover also the cylindrical surface 13a of the hub, used to centre the flange of the brake rotor (not shown).

Finally, according to alternative (but not illustrated) embodiments, the non-oxidisable insert 20, 20′ can be fixed to the hub by welding or adhesive.

What is claimed is:

1. A hub assembly for a wheel of a motor vehicle, including a hub which forms a central axial tubular projection with an outer cylindrical surface for inserting into a central hole in a vehicle wheel, and an insert of a non-oxidisable metal with a cylindrical portion fixed to the cylindrical surface of the hub so as to cover the said cylindrical surface.

2. A hub assembly according to claim 1, wherein the cylindrical portion of the non-oxidisable insert has an outer cylindrical surface which has been machined to obtain a desired final diameter.

3. A hub assembly according to claim 1, wherein the non-oxidisable insert is annular with a substantially L-shape section, with
a cylindrical portion covering the said cylindrical surface of the hub, and
a radial edge bearing against an outer surface of the tubular projection

4. A hub assembly according to claim 1, wherein the non-oxidisable insert is formed as a cap with
a cylindrical portion covering the said cylindrical surface of the hub, and
a full radial wall for closing a central aperture in the hub of a non driving wheel.

5. A hub assembly according to claim 1, wherein the tubular projection of the hub has at least one radial recess and the cylindrical portion of the non-oxidisable insert is plastically deformed into the said radial recess.

6. A hub assembly according to claim 5, wherein the cylindrical portion of the non-oxidisable insert has at least one axially inner edge deformed plastically into a radial recess in the form of a groove in the tubular projection of the hub.

7. A hub assembly according to claim 1, wherein the insert extends to cover a further cylindrical surface of the hub which is provided to centre the flange of a brake rotor.

8. A hub assembly according to claim 1, wherein the non-oxidisable insert is made of stainless steel or brass.

9. A hub assembly according to claim 1, wherein the non-oxidisable insert is force fitted with radial interference onto the cylindrical surface of the hub.

10. A hub assembly according to claim 1, wherein the non-oxidisable insert has a portion which extends to cover a cylindrical surface of the hub which is used to centre the flange of a brake rotor.

11. A method for manufacturing a hub assembly for a wheel of a motor vehicle, including the steps of:
(a) providing a hub forming a central axial tubular projection with an outer cylindrical surface for inserting into the central hole in a wheel;
(b) providing an insert of a non-oxidisable metal with a cylindrical portion the radial dimensions of which enable it to be force fitted onto the cylindrical surface of the hub and the axial dimensions of which enable it to cover the said cylindrical surface of the hub; and
(c) fixing the non-oxidisable insert onto the tubular projection of the hub in such a way that the cylindrical portion of the insert covers at least the said cylindrical surface.

12. A method according to claim 11, wherein step (c) is followed by a step of:
(d) machining an outer cylindrical surface of the cylindrical portion of the non-oxidisable insert to obtain a desired final diameter.

13. A method according to claim 12, wherein the steps (a) and (b) include the steps of:
(a1) providing a hub in which the diameter of the cylindrical surface of the tubular projection is smaller than the desired final diameter
(b1) selecting the radial dimensions of the insert such that once mounted in step (c) but before being machined in step (d), the non-finished diameter of the outer cylindrical surface of the cylindrical portion of the insert is greater than the desired final diameter.

14. A method according to claim 13, wherein the step (a1) includes the step of:
(a2) machining the cylindrical surface of the tubular projection in such a way that this cylindrical surface has a diameter smaller than the desired final diameter.

15. A method according to any one of claims 11 to 14, wherein the tubular projection of the hub has at least one radial recess, and wherein the step (c) is followed immediately by the step of:
(c1) plastically deforming at least part of the cylindrical portion of the insert into the radial recess.

16. A method according to any one of claims 11 to 15, wherein the fixing step (c) includes the step of force fitting the non-oxidisable insert onto the cylindrical surface of the hub with radial interference.

17. A method according to any one of claims 11 to 16, wherein the fixing step (c) includes the step of welding or gluing the non-oxidisable insert to the cylindrical surface of the hub.
